(19) United States
(12) Patent Application Publication
(10) Pub. No.: US 2025/0196831 A1
(43) Pub. Date: Jun. 19, 2025

(54) ACCUMULATOR WITH FAST FILL SUPPLY VALVE AND BRAKE SYSTEM USING SAME

(71) Applicant: ZF Active Safety US Inc., Livonia, MI (US)

(72) Inventor: Blaise Ganzel, Ann Arbor, MI (US)

(21) Appl. No.: 18/544,551

(22) Filed: Dec. 19, 2023

(51) Int. Cl. B60T 13/14; B60T 8/1755; B60T 8/94; B60T 13/58; B60T 13/74

(52) U.S. Cl. CPC B60T 13/145; B60T 8/1755; B60T 8/94; B60T 13/58; B60T 13/745

(57) ABSTRACT

An accumulator assembly includes a medium pressure accumulator, having an MPA cavity including a brake-side passage and a pump-side passage. A nonpowered MPA fill valve is interposed fluidically between the pump-side passage of the MPA cavity and a source of pressurized hydraulic fluid. An MPA fill valve seat is located along an MPA fill valve fluid path. An MPA fill valve poppet is configured for reciprocal motion between a poppet rest position and a poppet closed position wherein an MPA fill valve poppet shoulder contacts the MPA fill valve seat to occlude fluid flow therepast. A powered MPA one-way valve is interposed fluidically between the brake-side passage and at least one corresponding wheel brake.

### RELATED APPLICATIONS

This application is related to the technologies disclosed in one or more of U.S. Provisional Patent Application No. 63/580,042 (attorney docket no. 301699-US-PSP), filed 1 Sep. 2023 and titled “Brake Systems with Motor-Driven Master Cylinders and Low Pressure Accumulators”; U.S. Provisional Patent Application No. 63/580,048 (attorney docket no. 301647-US-PSP), filed 1 Sep. 2023 and titled “Brake Systems with Motor-Driven Master Cylinders and Pump Inlet Attenuators”; U.S. patent application Ser. No. 18/474,714 (attorney docket no. 301647-US-NP), filed 26 Sep. 2023 and titled “Brake Systems with Motor-Driven Master Cylinders and Pump Inlet Attenuators”; U.S. patent application Ser. No. 18/474,657 (attorney docket no. 301158-US-NP), filed 26 Sep. 2023 and titled “Brake Systems with Motor-Driven Master Cylinders and Bypass Valves” (hereafter referenced as “the '657 application”); and U.S. patent application Ser. No. 18/474,678 (attorney docket no. 301699-US-NP), filed 26 Sep. 2023 and titled “Brake Systems with Motor-Driven Master Cylinders and Low Pressure Accumulators”; the entire contents of all of which are incorporated herein by reference for all purposes.

### TECHNICAL FIELD

This disclosure relates to an apparatus and method for use of an accumulator with a fast fill supply valve and a brake system using same, and, more particularly, to methods and apparatuses of brake systems with medium pressure accumulators having associated two-way solenoid valves.

### BACKGROUND

A brake system may include anti-lock control including a hydraulic braking pressure generator, a braking pressure modulator which is provided in the pressure fluid conduits between the braking pressure generator and the wheel brakes and which serves to vary the braking pressure by changing the volume of a chamber containing the hydraulic fluid, sensors for determining the wheel rotational behavior, and electronic circuits for processing the sensor signals and for generating braking-pressure control signals. Brake systems may also include both anti-lock control and traction slip control, which can use braking pressure modulators for controlled vehicular braking.

It may be desirable to provide pressurized hydraulic fluid to a brake on an expedited basis, for some use environments (e.g., a “spike apply”, when the user “slams on” the brakes). Therefore, storage of pressurized hydraulic fluid in closer proximity to the brakes than the source(s) of the pressurized hydraulic fluid may be helpful in facilitating quick braking response, in some use environments.

For example, some brake systems include a “running clearance” distance between the brake pads and rotors, to avoid unwanted drag and wear on the brakes when they are not in use. Particularly in a “spike apply” situation, a user may wish to quickly take up that running clearance distance, to avoid a delay (or the perception thereof by a driver) in brake actuation.

Descriptions of prior art brake systems are in U.S. Pat. No. 10,730,501, issued 4 Aug. 2020 to Blaise Ganzel and titled “Vehicle Brake System with Auxiliary Pressure Source”, in U.S. Patent Application Publication No. 2020/0307538, published 1 Oct. 2020 by Blaise Ganzel and titled “Brake System with Multiple Pressure Sources”, and in U.S. Patent Application Publication No. 2023/0048447, published 16 Feb. 2023 by Blaise Ganzel and titled “Apparatus and Method for Control of a Hydraulic Brake System Including Manual Pushthrough”, all of which are incorporated herein by reference in their entirety for all purposes.

### SUMMARY

In an aspect, alone or in combination with any other aspect, an accumulator assembly is described. The accumulator assembly includes a medium pressure accumulator, having an MPA cavity including at least one brake-side passage adjacent a first end thereof and including at least one pump-side passage adjacent the first end thereof. An MPA piston is provided for reciprocal longitudinal motion within the MPA cavity responsive to a predetermined amount of hydraulic fluid flow through at least one of the pump-side passage and the brake-side passage. An MPA biasing spring is provided for urging the MPA piston toward the first end of the MPA cavity. A nonpowered MPA fill valve is interposed fluidically between the pump-side passage of the MPA cavity and a source of pressurized hydraulic fluid. The MPA fill valve includes an MPA fill valve cavity placing the pump-side passage of the MPA cavity and the source of pressurized hydraulic fluid in selective fluid communication via an MPA fill valve fluid path. An MPA fill valve seat is located along the MPA fill valve fluid path and is at least partially defined by an interior wall of the MPA fill valve cavity. An MPA fill valve poppet is configured for reciprocal motion between a poppet rest position and a poppet closed position wherein an MPA fill valve poppet shoulder contacts the MPA fill valve seat to occlude fluid flow therepast along the MPA fill valve fluid path. An MPA fill valve biasing spring urges the MPA fill valve poppet toward the poppet closed position.

The MPA fill valve poppet selectively reciprocates responsive to at least one of biasing force from the MPA valve biasing spring and a fluid pressure differential between the source of pressurized hydraulic fluid and the MPA cavity. A powered MPA one-way valve is interposed fluidically between the brake-side passage of the MPA cavity and the at least one corresponding wheel brake. The MPA one-way valve includes an MPA one-way valve cavity placing the brake-side passage of the MPA cavity and the at least one corresponding wheel brake in selective fluid communication via an MPA one-way valve fluid path. An MPA one-way valve seat is located along the MPA one-way valve fluid path and is defined by an interior wall of the MPA one-way valve cavity. An MPA one-way valve poppet is configured for reciprocal motion between a poppet open position and a poppet closed position wherein an MPA one-way valve poppet shoulder selectively contacts the MPA one-way valve seat to occlude fluid flow therepast along the MPA one-way valve fluid path. Reciprocal motion of the MPA one-way valve poppet occurs at least partially responsive to a predetermined amount of fluid pressure differential between the MPA cavity and the at least one corresponding wheel brake.

### BRIEF DESCRIPTION OF THE DRAWINGS

For a better understanding, reference may be made to the accompanying drawings, which are not drawn to scale, and in which:

FIG. 1 is a schematic cross-sectional view of a portion of a brake system, according to an aspect of the present invention;

FIG. 2 is a schematic cross-sectional view of a component of the portion of the brake system of FIG. 1, in a first condition;

FIG. 3 is a schematic detail view of area “3” of FIG. 2;

FIG. 4 is a schematic cross-sectional view of the component of FIG. 2, in a second condition;

FIG. 5 is a schematic cross-sectional view of the component of FIG. 2, in a third condition;

FIG. 6 is a schematic detail view of area “6” of FIG. 5;

FIG. 7 is a schematic cross-sectional view of another component of the portion of the brake system of FIG. 1, in a first condition;

FIG. 8 is a schematic cross-sectional view of the component of FIG. 2, in a second condition;

FIG. 9 is a schematic cross-sectional view of the component of FIG. 2, in a third condition;

FIG. 10 is a schematic hydraulic diagram of an example brake system incorporating the components of FIGS. 1, 5, and 8;

FIG. 11 is a perspective schematic front view of an example physical arrangement of the brake system of FIG. 10; and

FIG. 12 is a perspective schematic rear view of the example physical arrangement shown in FIG. 11.

### DESCRIPTION OF ASPECTS OF THE DISCLOSURE

Unless defined otherwise, all technical and scientific terms used herein have the same meaning as is commonly understood by one of ordinary skill in the art to which the present disclosure pertains.

The invention comprises, consists of, or consists essentially of the following features, in any combination.

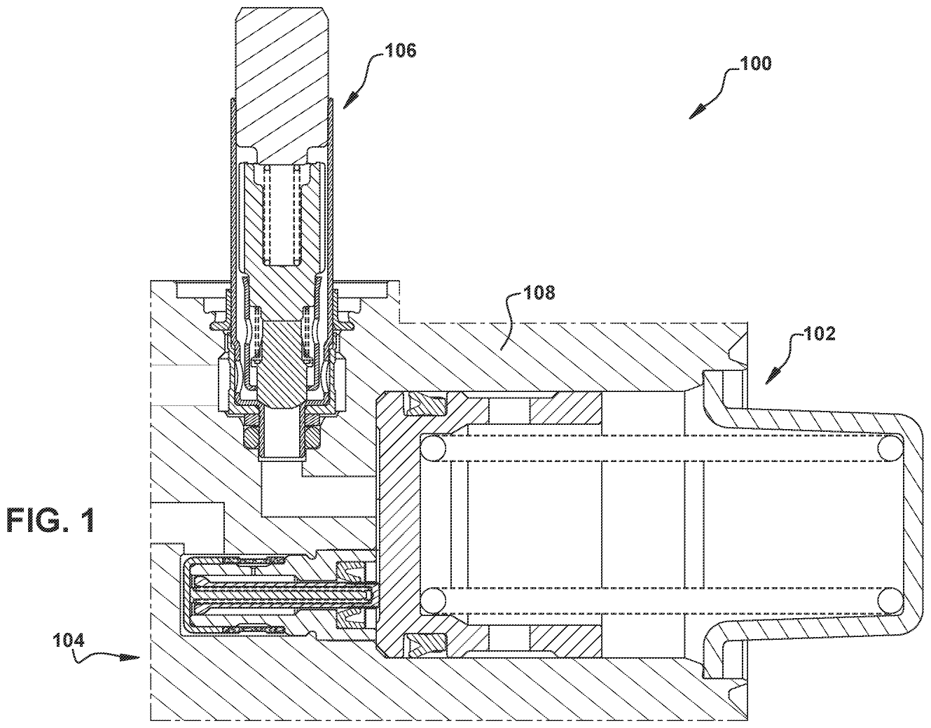

FIG. 1 schematically depicts an accumulator assembly 100, comprising a medium pressure accumulator 102, a nonpowered MPA fill valve 104, and a powered MPA one-way valve 106. The term “medium pressure” is used to indicate that the accumulator 102 is configured to hold, for example, an operating pressure of between about 3.9 and about 5.5 bar, in some use environments. This pressure capacity can be adjusted as desired by one of ordinary skill in the art by changing a size, shape, available spring force, configuration, and/or another property of at least one component of the medium pressure accumulator 102. The accumulator assembly 100 may be used, for example, in conjunction with a brake system, as will be discussed below in more detail. As a result of this “medium pressure” capability, the accumulator assembly 100 may have capacity for usefully storing (temporarily or permanently) and providing pressurized hydraulic fluid to other components of the brake system at a location that would not be practical for positioning of a lower-pressure accumulator (not shown). The accumulator assembly 100 can be housed in a block housing 108, shown schematically in the Figures, which may define components of the accumulator assembly 100; assist with assembling and maintaining components of the accumulator assembly 100 into an assembled device; and/or provide other housing, assembly, and/or maintenance functions as desired to any other components of the brake system.

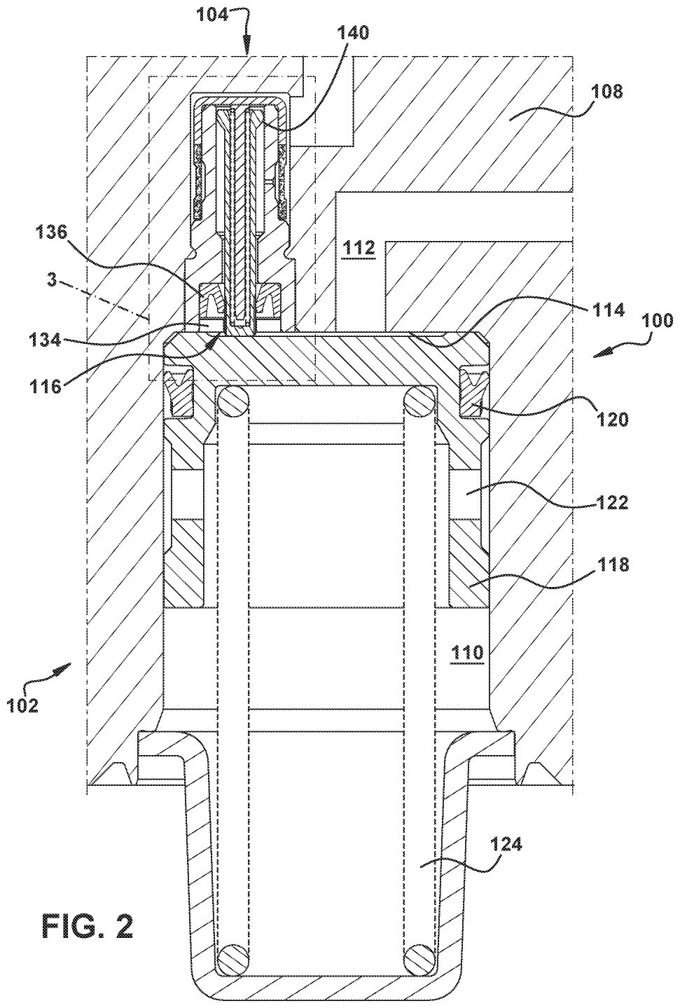

The medium pressure accumulator 102 includes an MPA cavity 110 including at least one brake-side passage 112 at and/or adjacent a first end 114 of the MPA cavity 110 and at least one pump-side passage 116 also at and/or adjacent the first end 114 of the MPA cavity 110. The MPA cavity 110 may be vented to atmosphere at a location spaced apart from the first end 114, as desired. An MPA piston 118 is configured for reciprocal longitudinal motion within the MPA cavity 110 responsive to a predetermined amount of hydraulic fluid flow through at least one of the pump-side passage 116 and the brake-side passage 112. The “longitudinal” direction, as referenced herein pertaining to the MPA fill valve 104, is substantially parallel to arrow “L”, and is depicted as a vertical direction, in the orientation of FIG. 2. The MPA piston 118 can include at least one piston seal 120, piston passage 122 for allowing routing “through” the MPA piston 118, or any other desired features, as can be configured by one of ordinary skill in the art. An MPA biasing spring 124 is provided for urging the MPA piston 118 toward the first end 114 of the MPA cavity 110.

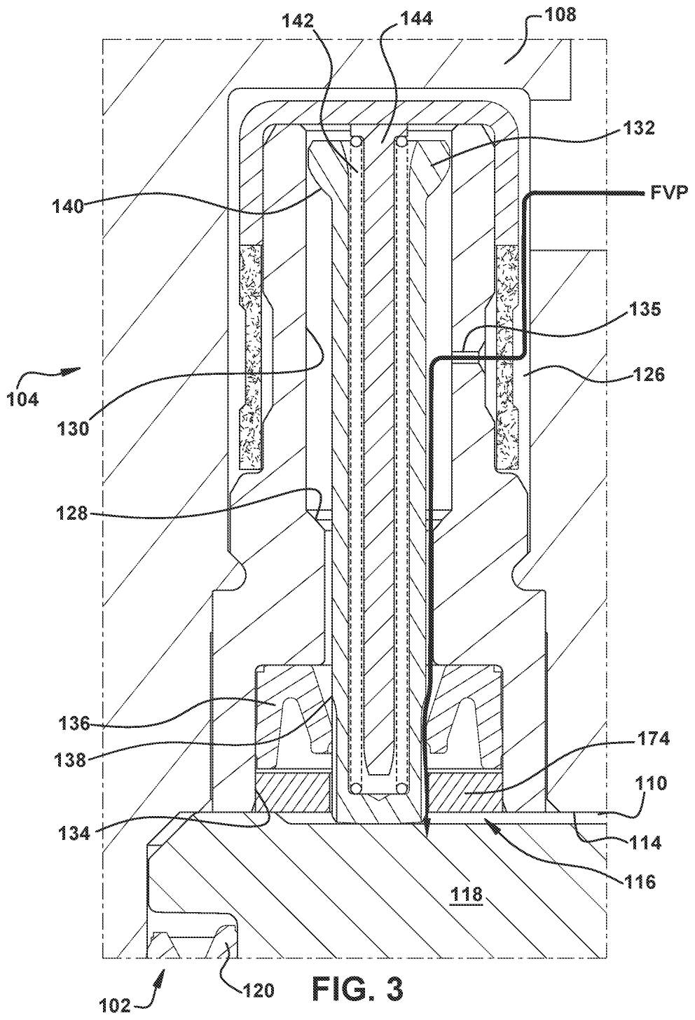

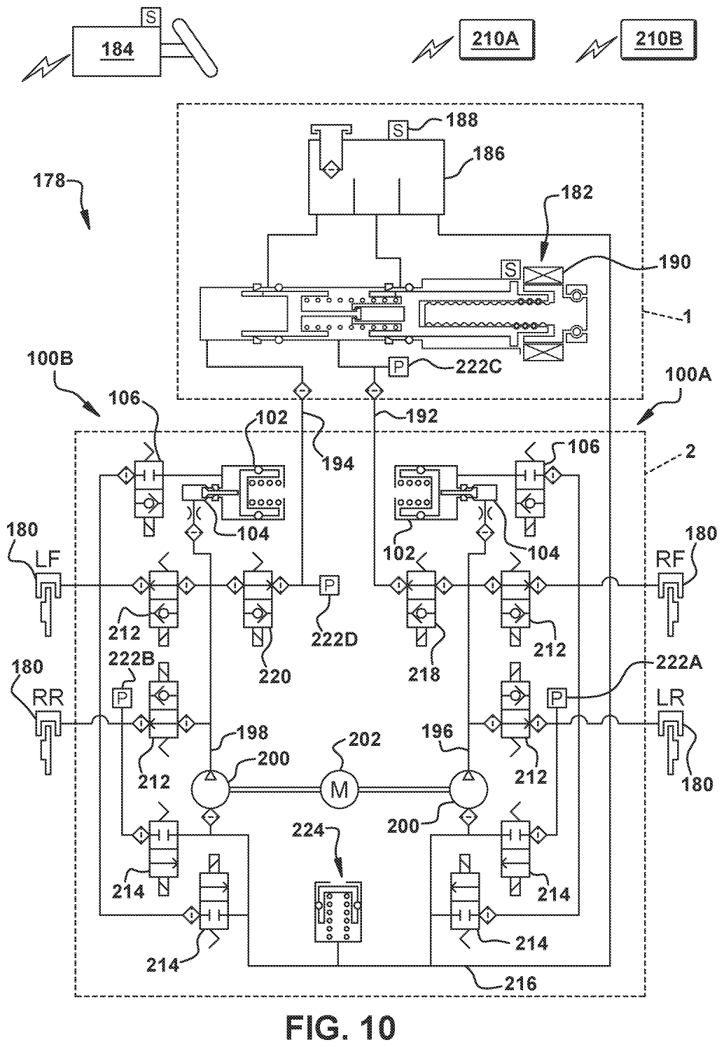

The nonpowered MPA fill valve 104 is interposed fluidically between the pump-side passage 116 of the MPA cavity 110 and a source of pressurized hydraulic fluid, which may be at least one of a pump piston of a secondary brake module and a master cylinder, as will be discussed with reference to the brake system of FIG. 10. The MPA fill valve 104 includes an MPA fill valve cavity 126 placing the pump-side passage 116 of the MPA cavity 110 and the source of pressurized hydraulic fluid in selective fluid communication via an MPA fill valve fluid path, shown schematically as FVP in FIG. 3 and discussed below in more detail. An MPA fill valve seat 128 is located along the MPA fill valve fluid path FVP and is at least partially defined by an interior wall 130 of the MPA fill valve cavity 126. An MPA fill valve poppet 132 is configured for reciprocal motion at least between a poppet rest position and a poppet closed position, as will now be discussed further with reference to FIGS. 2-6.

Turning to FIGS. 2-3, the MPA fill valve cavity 126 includes an annular groove 134 adjacent (e.g., extending continuously from) the pump-side passage 116 of the MPA cavity 110. The annular groove 134 is configured to retain a directional MPA lip seal 136 therein. The MPA lip seal 136 selectively permits hydraulic fluid flow therepast toward the MPA cavity 110 along the MPA fill valve fluid path FVP, which is a one-way fluid flow path during many phases of operation of the MPA fill valve 104 at least due to the directional sealing nature of the MPA lip seal 136.

However, it is contemplated that the MPA lip seal 136 may selectively permit airflow therepast toward the source of pressurized fluid “backward” along the MPA fill valve fluid path FVP in a reverse direction than that indicated by the arrows along FVP in certain circumstances, which are contemplated to occur only extremely rarely over the entire expected lifespan of the accumulator assembly 100. In the configuration shown in FIGS. 2-3, the MPA fill valve poppet 132 is in a fully retracted, “initial” position in which the accumulator assembly 100 is provided to, for example, a vehicle manufacturer for initial assembly into a brake system.

The MPA fill valve fluid path FVP may include an MPA orifice 135 therealong, which serves to restrict fluid flow along the MPA fill valve fluid path FVP and into the medium pressure accumulator 102. The MPA orifice may be configured by one of ordinary skill in the art for a particular use application, and may be about 0.25 mm diameter for the accumulator assembly 100 configuration given via example quantifications herein. The MPA orifice 135, and the fluid flow restriction it provides, may be helpful in avoiding unwanted “dumping” or “cycling” of the fluid volume that comes out through the MPA one-way valve 106 to then just end up going back into the MPA cavity 110 through the MPA fill valve 104.

In the initial position of FIGS. 2-3, the MPA fill valve poppet 132 is configured to provide an MPA bleed port function during a non-powered evac/fill phase of lifetime operation of the accumulator assembly 100. The term “lifetime operation” is used herein to indicate that a particular function may arise or occur at some point(s) during the lifetime of the brake as desired, but is not contemplated to often happen as a regular function during normal operation. This non-powered evac/fill phase is contemplated as occurring only during an initial startup of the brake system (for the first time ever), and/or in the unlikely event that the entire brake system of an in-service vehicle has been at least partially emptied of hydraulic fluid during non-routine maintenance and needs to be refilled. It is also contemplated that an MPA bleed port function may be used, for example, if a vehicle containing the accumulator assembly 100 was parked for an extended period of time and the pressurized hydraulic fluid within the MPA cavity 110 leaked down past a predetermined fill amount, or—as another example—if a “spike apply” of the brakes used a large amount of pressurized hydraulic fluid from the MPA cavity 100. Both of those situations might prompt a desire for a bleed port function to be performed.

Accordingly, to support this rarely-needed “bleed port” or “bleed valve” function—and thus remove normally-unwanted air from within the MPA cavity 110, the MPA fill valve poppet 132 includes an MPA bypass shoulder, shown at 138 in FIG. 3. The MPA bypass shoulder 138 selectively contacts an inner surface of the MPA lip seal 136 to occlude fluid flow (air, hydraulic fluid, or another fluid) therepast toward the source of pressurized fluid along the MPA fill valve fluid path FVP when there is no longer a desire for a bleed port function. As a result, when the MPA bypass shoulder 138 is in occluding contact with the MPA lip seal 136, then the MPA fill valve fluid path FVP is constrained to one-way operation, allowing hydraulic fluid to pass between the directional MPA lip seal 136 toward the MPA cavity 110. The term “occluding contact” is used herein to indicate that the MPA bypass shoulder 138 is in lateral contact with the MPA lip seal 136, or has passed “beyond” the MPA lip seal 136 toward the MPA cavity 110, so that the increased-diameter area of the MPA fill valve poppet 132 “behind” the MPA bypass shoulder 138 is in lateral contact with the MPA lip seal 136. The term “lateral” is used throughout this description to indicate a direction perpendicular to the longitudinal direction.

The MPA bypass shoulder 138 may be of any desired type and may extend continuously or discontinuously about a circumference of the MPA fill valve poppet 132—as an example of the latter, the area labeled as 138 in the Figures could represent a section through a longitudinally fluted or grooved area of the MPA fill valve poppet 132 body having one or more slots defining the MPA bypass shoulder 138. When the MPA bypass shoulder 138 is of a fluted or grooved type, the lip seal 136 normally will “bridge” laterally across such longitudinal voids and thus allow air to pass through the MPA bypass shoulder 138 area. One of ordinary skill in the art can readily configure a particular bleed port function providing structure for a particular use environment.

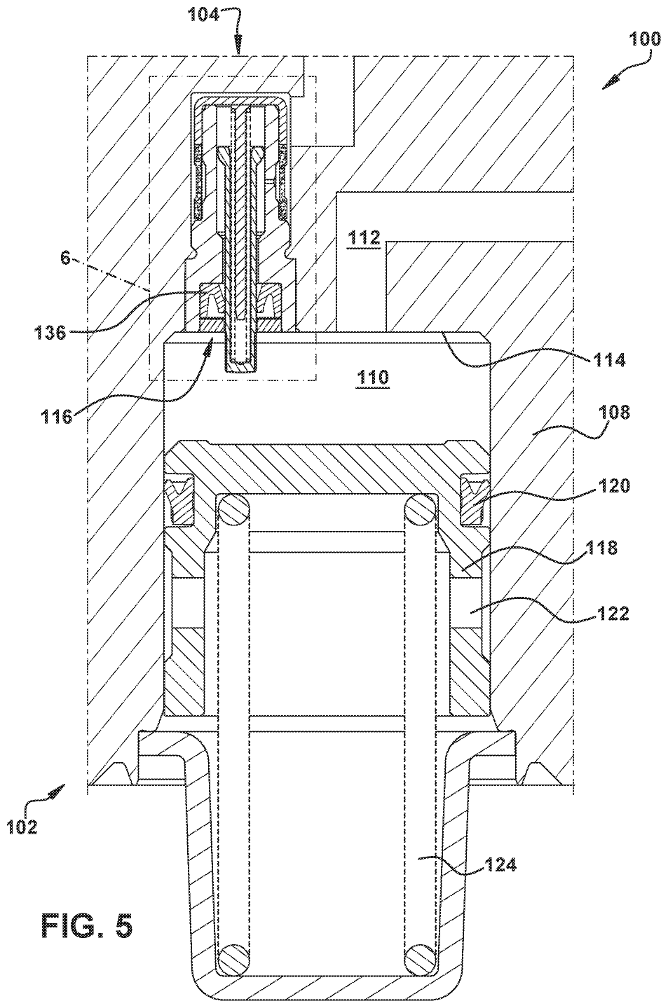

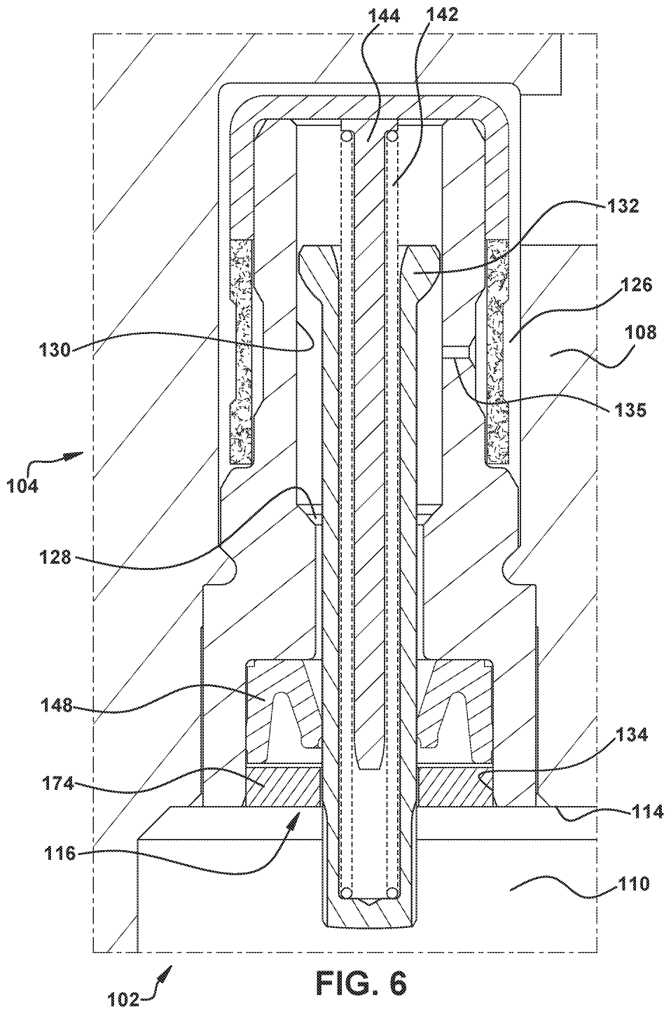

This situation as shown in FIGS. 5-6 as comprising the “rest position” of the MPA fill valve poppet 132. In the accumulator assembly 100 configuration shown in the Figures, a distal end of the MPA fill valve poppet 132 protrudes through the pump-side passage 116 into the MPA cavity 100, and is maintained at least partially within the MPA cavity 110—with the MPA bypass shoulder 138 in occluding contact with the inner surface of the MPA lip seal 136—once the non-powered evac/fill phase of lifetime operation of an associated brake system has been completed, or when there is no “bleed port” function desired. Accordingly, and in light of the above example situations wherein the MPA cavity 110 is devoid of a desired amount of fluid, it can be generally said that the MPA fill valve poppet 132 is maintained at least partially within the MPA cavity 110 with the MPA bypass shoulder 138 in occluding contact with the inner surface of the MPA lip seal 136 responsive to the MPA cavity 110 containing a predetermined fill amount of hydraulic fluid.

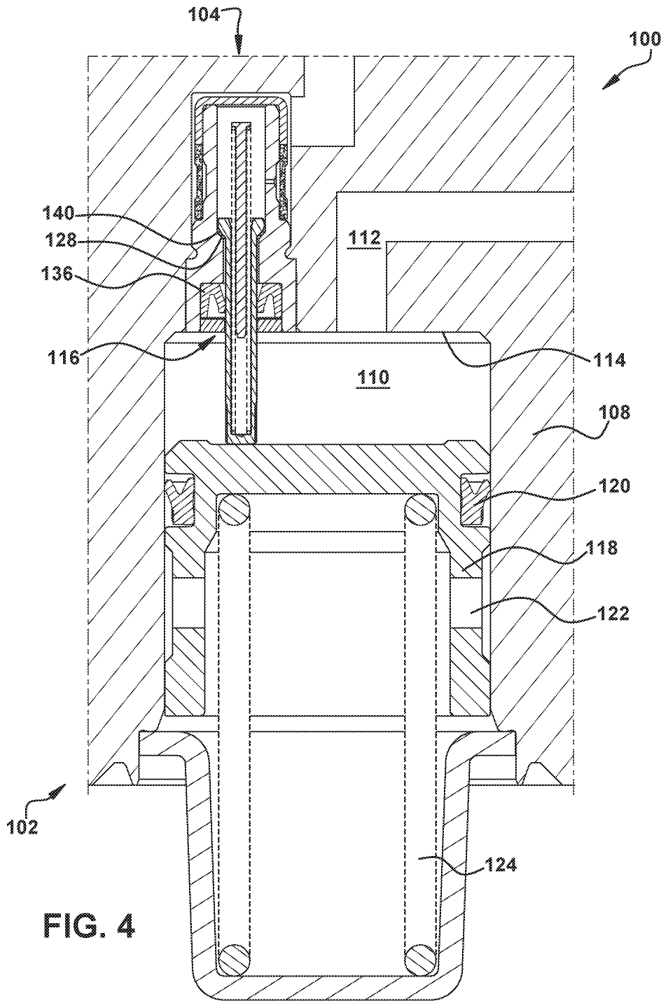

The MPA bypass shoulder 138 is spaced apart longitudinally apart along the MPA fill valve poppet 132 from an MPA poppet shoulder, shown at 140 in FIGS. 2-6. With reference to FIG. 4, the MPA fill valve poppet shoulder 140 selectively contacts the MPA fill valve seat 128 to occlude fluid flow therepast along the MPA fill valve fluid path FVP when the MPA fill valve poppet 132 is in a “closed” position. Reciprocal motion of the MPA fill valve poppet 132 between the rest (allowing fluid flow toward the MPA cavity 110 along the FVP, shown in FIGS. 5-6) and closed (substantially preventing fluid flow along the FVP, shown in FIG. 4) positions may occur at least partially responsive to an application status of at least one associated wheel brake, relative pressures within the MPA cavity 110 and at least one other component of the accumulator assembly 100, and/or the operation of at least associated one iso valve of an iso/valve control valve arrangement.

That is, the “rest position” allows for pressurized hydraulic fluid from a source of pressurized hydraulic fluid to travel along the MPA fill valve fluid path FVP and into the MPA cavity 110 until the MPA piston is pushed back, against the force of the MPA biasing spring 124, and the MPA cavity 110 is “full” with a predetermined fill amount of hydraulic fluid. An MPA fill valve biasing spring 142 (having an anti-buckling pin 144 associated therewith) urges the MPA fill valve poppet 132 toward the poppet closed position, which is attained—the MPA poppet shoulder 140 accordingly coming into occluding contact with the MPA fill valve seat 128—when the MPA cavity 110 contains the predetermined fill amount of hydraulic fluid. Once the MPA fill valve poppet 132 is in the “closed” position, no further pressurized hydraulic fluid flows into the MPA cavity 110 along the MPA fill valve fluid path FVP. However, under certain circumstances (e.g., a predetermined pressure differential between a source of pressurized hydraulic fluid and the MPA cavity 110), once the MPA bypass shoulder 138 in occluding contact with the inner surface of the MPA lip seal 136 hydraulic fluid can be urged to travel between the MPA fill valve 104 and the MPA cavity 110 by traveling between the MPA fill valve poppet 132 and the MPA lip seal 136.

At least a first length of the MPA fill valve poppet 132 is located within the MPA cavity 110 when the MPA cavity 110 includes the predetermined fill amount of hydraulic fluid. This is the configuration shown in FIG. 4. In the sequence of views running from FIG. 4 through to FIG. 5, then, the MPA fill valve poppet 132 selectively reciprocates within the MPA fill valve cavity 110 responsive to at least one of biasing force from the MPA valve biasing spring 142 and a fluid pressure differential between the source of pressurized hydraulic fluid and the MPA cavity 110. (E.g., the fluid pressure within the MPA cavity 110 works to overcome the biasing force from the MPA valve biasing spring 142, move the MPA poppet shoulder 140 away from the MPA fill valve seat 128, and thus obtain more pressurized fluid from the pressurized fluid source.)

A second length of the MPA fill valve poppet 132 (represented schematically as being smaller than the first length of the MPA fill valve poppet 132) protrudes into, and remains located within, the MPA cavity 110, as shown in FIGS. 5-6, when the MPA cavity 110 includes substantially the predetermined fill amount of hydraulic fluid and/or there is a predetermined pressure differential between the MPA cavity 110 and the source of hydraulic fluid. Because the second length of the MPA fill valve poppet 132 represents an amount that allows the MPA fill valve poppet 132 to be in the “rest” position”, any desired amount of pressurized hydraulic fluid is permitted to flow along the MPA fill valve fluid path FVP and/or between the MPA fill valve poppet 132 and the lip seal 136. and routed through the brake system in a predetermined manner; one of ordinary skill in the art can readily provide a suitably configured accumulator assembly 100 and/or brake system to achieve a desired braking performance for a particular use environment.

Alternative configurations (not shown) which may be suitable for particular use environments include, but are not limited to, attaching the MPA fill valve poppet 132 directly or indirectly to the MPA piston 118 for reciprocal travel therewith; configuring the MPA biasing spring 124 to hold the MPA fill valve poppet 132 into reciprocating contact with the MPA piston 118 for reciprocal travel therewith; providing a blocking component and/or mechanism to permanently prevent the “bleed valve” fluid flow backward up the MPA fill valve fluid path FVP after the initial non-powered evac/fill process; and/or intentionally leaving a small amount of air in the MPA cavity 110 after the initial non-powered evac/fill process and subsequently operating one or more other components of the brake system, optionally in a cyclical manner, to provide a self-bleed function that sends the small “remainder” amount of air from the MPA cavity 110 out of the brake system.

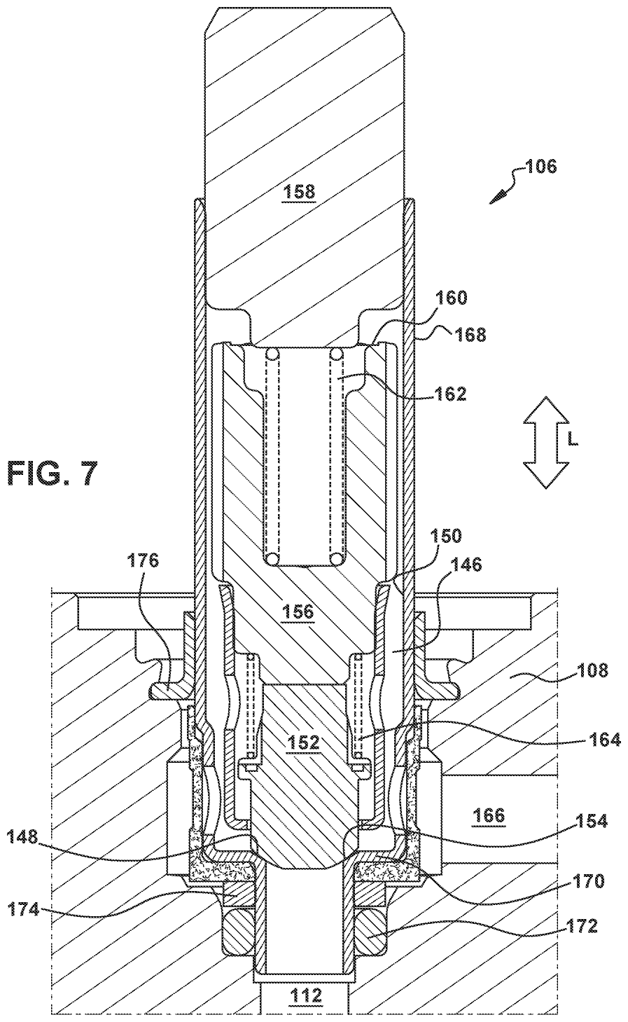

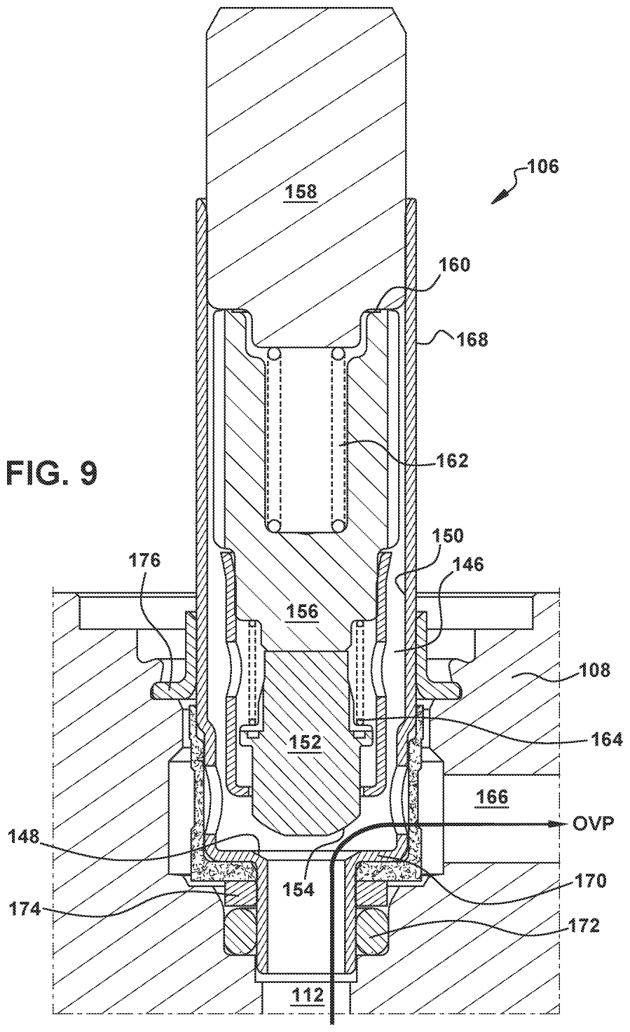

FIGS. 7-9 schematically depict the structures and operation of a powered MPA one-way valve 106 which is interposed fluidically between the brake-side passage 112 of the MPA cavity 110 and at least one corresponding wheel brake. The MPA one-way valve 106 includes an MPA one-way valve cavity 146 placing the brake-side passage 112 of the MPA cavity 110 and the at least one corresponding wheel brake in selective fluid communication via an MPA one-way valve fluid path OVP (shown schematically in FIG. 9). An MPA one-way valve seat 148 is located along the MPA one-way valve fluid path OVP and is defined by an interior wall 150 of the MPA one-way valve cavity 146.

An MPA one-way valve poppet 152 is configured for reciprocal motion between a poppet open position and a poppet closed position. When the MPA one-way valve poppet 152 is in the poppet closed position, an MPA one-way valve poppet shoulder 154 contacts the MPA one-way valve seat 148 to occlude fluid flow therepast along the MPA one-way valve fluid path OVP. Reciprocal motion of the MPA one-way valve poppet 152 occurs at least partially responsive to a predetermined amount of fluid pressure differential between the MPA cavity 110 and the at least one corresponding wheel brake, as will be described below.

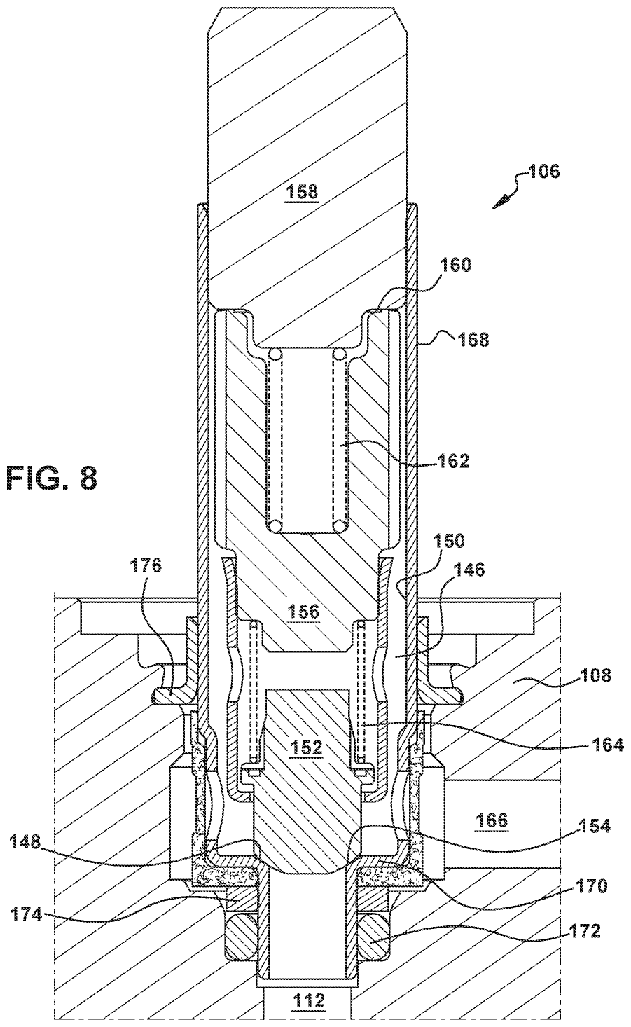

The MPA one-way valve 106 includes an armature 156 for selective longitudinally reciprocating motion with respect to the MPA one-way valve cavity 146 between first and second armature positions (shown in FIGS. 7, and 8-9, respectively). The “longitudinal” direction, as referenced herein with respect to the MPA one-way valve, is substantially parallel to arrow “L”, and is depicted as a vertical direction, in the orientation of FIG. 7. The MPA one-way valve 106 includes a core 158 for selectively magnetically attracting the armature 156. The core 158 is located longitudinally directly adjacent a core-activated surface 160 of the armature 156. The armature 156 is longitudinally interposed between the core 158 and the MPA one-way valve poppet 152. The core 158 is selectively energized to magnetically drive the armature 156 between the first armature position of FIG. 7 and the second armature position of FIGS. 8-9. A core spring 162 biases the armature 156 toward the MPA one-way valve poppet 152—i.e., toward the first armature position—to make the MPA one-way valve 106 a normally-closed type of valve, which is then electrically (solenoid) actuated to selectively open.

The MPA one-way valve poppet 152 is held into engagement with the MPA one-way valve seat 148, in the poppet closed position, responsive to the armature 156 being in the first armature position. As a result, the MPA one-way valve fluid path OVP is occluded when the armature 156 is in the first armature position, and pressurized hydraulic fluid is not permitted to travel from the medium pressure accumulator 102 toward the wheel brake. The MPA one-way valve poppet 152 is permitted to selectively reciprocate between the poppet closed position of FIG. 8 and the poppet open position of FIG. 9 responsive to the armature 156 being in the second armature position. As a result, the MPA one-way valve fluid path OVP may be occluded when the armature 156 is in the second armature position, or may not be occluded at that time, depending upon the position of the MPA one-way valve poppet 152.

A poppet spring 164 biases the MPA one-way valve poppet 152 toward the poppet closed position and thus biases the MPA one-way valve poppet shoulder 140 toward sealing engagement with the MPA one-way valve seat 148 when the armature 156 is in the second armature position. Again, this is the arrangement shown in FIG. 8. Conversely, reciprocal motion of the MPA one-way valve poppet 152 from the poppet closed position of FIG. 8 toward the poppet open position of FIG. 9 is permitted to occur at least partially responsive to a fluid pressure in the MPA cavity 110 (i.e., in the brake-side passage 112) being greater than a predetermined wheel-side fluid pressure (i.e., in the wheel-side passage represented by 166), which is related to fluid pressure at the at least one corresponding wheel brake, optionally adjusted to account for pressure drop occurring in an intervening length of hydraulic line travel. When the MPA one-way valve poppet 152 is urged toward the poppet open position of FIG. 9 by fluid pressure from the brake-side passage 112, the MPA one-way valve fluid path OVP is permitted to open, and pressurized hydraulic fluid flows through the MPA one-way valve 106, along the MPA one-way valve fluid path OVP, toward the brake to facilitate a “spike apply”, or otherwise to provide pressurized hydraulic fluid to the wheel brake in a desired manner for operation of the brake system.

The MPA one-way valve 106 may be configured and constructed in any desired manner, and may readily be provided by one of ordinary skill in the art for a desired use environment. By way of example, given the medium pressures previously mentioned, the MPA one-way valve fluid path OVP might be configured to take about 10 bars of force from the brake-side passage 112 direction (to overcome spring force of at least one of the core and poppet springs 162 and 164) to open when the MPA one-way valve 106 is in the FIG. 7 configuration, about 80 mbars (to overcome the force of the poppet spring 164 and shift the MPA one-way valve poppet 152 initially) to start opening in the FIG. 8 configuration, and about 180 mbars (to move the MPA one-way valve poppet 152 fully away from the MPA one-way valve seat 148) to fully open into the FIG. 9 configuration.

The example MPA one-way valve 106 configuration shown in the Figures includes a core sleeve 168 received at least partially in a housing 108 that also at least partially defining the MPA cavity 110. The core sleeve 168, when present, is configured to maintain the core 158 in spaced relationship with the armature 156. The armature 156 is at least partially enclosed within the core sleeve 168 is and guided thereby for selective longitudinal reciprocating motion with respect to the core 158, responsive to energization of the core 158. Optionally, and also as shown in the Figures, the core sleeve 168 may completely enclose the MPA one-way valve poppet 152.

The core sleeve 168 is shown as having a reduced-diameter sleeve shoulder 170, located on an opposite end of the MPA one-way valve poppet 152 from the core 158. The sleeve shoulder 170 at least partially defines the MPA one-way valve seat 148 by comprising at least a portion of an interior wall 150 of the MPA one-way valve cavity 146, at that location on the MPA one-way valve 106. Any desired number, configuration, and type of resilient seals 172, to prevent fluid leakage; retainers 174, to keep the components of the MPA one-way valve 106 spaced or arranged as desired; and/or flanges 176, to maintain the MPA one-way valve 106 within the block housing 108, may be provided by one of ordinary skill in the art for a particular use environment of the accumulator assembly 100.

FIG. 10 schematically depicts an example brake system 178 for actuating a plurality of wheel brakes 180 comprising first and second pairs of wheel brakes 180. The brake system 178 is shown here as a hydraulic braking system, in which fluid pressure is utilized to apply braking forces for the brake system 178. The brake system 178 may suitably be used on a ground vehicle, such as an automotive vehicle having four wheels with a wheel brake associated with each wheel. Furthermore, the brake system 178 can be provided with other braking functions such as anti-lock braking (ABS) and other slip control features to effectively brake the vehicle. Components of the brake system 178 may be housed in one or more blocks or housings. The blocks or housings may be made from solid material, such as aluminum, that has been drilled, machined, or otherwise formed to house the various components. Fluid conduits may also be formed in the block or housing.

In the illustrated embodiment of the brake system 178 of FIG. 10, there are four wheel brakes 180, which each can have any suitable wheel brake structure operated electrically and/or by the application of pressurized brake fluid. Each of the wheel brakes 180 may include, for example, a brake caliper mounted on the vehicle to engage a frictional element (such as a brake disc) that rotates with a vehicle wheel to effect braking of the associated vehicle wheel. The wheel brakes 180 can be associated with any combination of front and rear wheels of the vehicle in which the corresponding brake system 178 is installed. For example, the brake system 178 may be configured as a vertically split or diagonally split system. No differentiation is made herein among the construction of the various wheel brakes 180, for the purposes of this description, though one of ordinary skill in the art could readily provide a suitable braking arrangement for a particular use environment. The wheel brakes 180 are described herein as comprising first and second pairs of wheel brakes 180, with the first and second pairs being characterized as RF/LR and LF/RR, as shown as FIG. 10, for the sake of description. However, LF/LR and RF/RR, or RF/LF and RR/LR, pairs could also or instead be specified for the brake system 178, as desired.

Also for the sake of description, it is presumed that a deceleration signal transmitter (shown schematically at 184) is configured to provide a braking signal, in a wired or wireless manner, corresponding to a desired braking action by an operator of the vehicle. The deceleration signal transmitter 184 could include, but not be limited to, a brake pedal, an autonomous braking controller, and/or any other suitable scheme for generating a braking signal from which the brake system 178 can be actuated.

The brake system 178 also includes a fluid reservoir 186. The reservoir 186 stores and holds hydraulic fluid for the brake system 178. The fluid within the reservoir 186 is preferably held at or about atmospheric pressure, but the fluid may be stored at other pressures if desired. The reservoir 186 is shown schematically as having three tanks or sections in FIG. 10, with fluid conduit lines connected thereto. The sections can be separated by several interior walls within the reservoir 186 and are provided to prevent complete drainage of the reservoir 186 in case one of the sections is depleted due to a leakage via one of the three lines connected to the reservoir 186. Alternatively, the reservoir 186 may include multiple separate housings. The reservoir 186 may include at least one fluid level sensor 187 for detecting the fluid level of one or more of the sections of the reservoir 186.

The motor-driven master cylinder (“MC” or “[primary] power transmission unit”) 182 (which may be a dual-chamber type master cylinder 182, also known as a tandem power transmission unit) of the brake system 178 functions as a source of pressure to provide a desired pressure level to the hydraulically operated wheel brakes 180 during a typical or normal non-failure brake apply. An example of a suitable MC 182 arrangement is disclosed in co-pending U.S. patent application Ser. No. 17/708,070, filed 30 Mar. 2022 and titled “Tandem Power Transmission Unit and Brake Systems Using Same” (attorney docket no. 211835-US-NP), which is incorporated by reference herein in its entirety for all purposes. The master cylinder 182 is operable during a normal non-failure braking mode by actuation of an electric motor 190 of the master cylinder 182 to generate brake actuating pressure at first and second MC outputs 192 and 194, respectively, for hydraulically actuating the first and second pairs of wheel brakes 180.

After a brake apply, fluid from the wheel brakes 180 may be returned to the master cylinder 182 and/or be diverted to the reservoir 186. It is also contemplated that other configurations (not shown) of the brake system 178 could include hydraulic control of just selected one(s) of the wheel brakes (with the others being electrically controlled/actuated). One of ordinary skill in the art would be readily able to provide such an arrangement for a desired use environment, following aspects of the present invention.

A secondary brake module is configured for selectively providing pressurized hydraulic fluid at first and second pump outputs 196 and 198, respectively, for actuating the first and second pairs of wheel brakes 180 in at least one of a normal non-failure braking mode and a backup braking mode. As shown in FIG. 10, the secondary brake module includes at least one pump piston 200 associated with at least one wheel brake 180 of the plurality of wheel brakes 180. The pump piston 200 is driven by an eccentric bearing (not shown) on a shaft of an electric pump motor 202 (as differentiated from the electric motor 190 included in the master cylinder 182) which transmits rotary motion to each pump piston 200 for selectively providing pressurized hydraulic fluid to an iso/dump control valve arrangement of at least one wheel brake 180 which is associated with the pump piston 200. FIG. 10 shows one pump piston 200 as being associated with two wheel brakes 180, for a total of two pump pistons 200 in the brake system 178. Together, the pump piston(s) 200 and electric pump motor 202 can be considered to comprise a secondary brake module (A.K.A. “secondary power transmission unit”) of the brake system 178. For example, the two pump pistons 200 shown in the Figures may provide pressurized hydraulic fluid at first and second pump outputs 196 and 198, respectively, to the corresponding wheel brakes 180 via the corresponding iso/dump control valve arrangements (when present), to actuate the first and second pairs of wheel brakes 180 in at least one of a normal non-failure braking mode and a backup braking mode. Each of the first and second pump outputs 196 and 198 can provide fluid to a corresponding one of the first and second pairs of wheel brakes 180. It is contemplated that a plurality of pump pistons 200 could be associated with each of the first and second pump outputs 196 and 198, in some configurations of the brake system 178.

The secondary brake module of the brake system 178 may function as a source of pressure to provide a desired pressure level to selected ones of the wheel brakes 180 in a backup or “failed” situation, when, for some reason, the master cylinder 182 is unable to provide fluid to those selected wheel brakes 180. Accordingly, the secondary brake module may be directly fluidly connected to the reservoir 186, for exchanging hydraulic fluid between these components without having to route the fluid through a (potentially failed) motor-driven master cylinder 182 or another structure of the brake system 178.

The secondary brake module can be used to selectively provide hydraulic fluid to at least one of the wheel brakes 180 in a backup braking mode, but also in an enhanced braking mode, which can occur on its own and/or concurrently with either the backup braking mode or a non-failure normal braking mode. Examples of suitable enhanced braking mode functions available to the brake system 178 may include, but not be limited to, “overboost” (in which higher pressure is provided to a particular brake than would normally be available from the master cylinder 182 alone) and “volume-add” (in which more fluid is provided to a particular brake than would normally be available from the master cylinder 182). These enhanced braking modes may be facilitated, in some use environments, by the pump piston(s) 200. For example, in at least one of the normal non-failure braking mode and the backup braking mode, the secondary brake module can then supply boosted-pressure (above what was obtained from the master cylinder 182) hydraulic fluid to at least one of the first and second pump outputs 196 and 198.

The brake system 178 shown in FIG. 10 also includes at least one electronic control unit (“ECU”) 210, for controlling at least one of the master cylinder 182 and the secondary brake module (via electric pump motor 202) responsive to at least one brake pressure signal, with first and second ECUs 210A, 210B being shown and described herein. The ECUs 210A, 210B may include microprocessors and other electrical circuitry. The ECUs 210A, 210B receive various signals, process signals, and control the operation of various electrical components of a corresponding brake system 178 in response to the received signals, in a wired and/or wireless manner. The ECUs 210A, 210B can be connected to various sensors such as the reservoir fluid level sensor(s) 187, pressure sensors, travel sensors, switches, wheel speed sensors, and steering angle sensors. The ECUs 210A, 210B may also be connected to an external module (not shown) for receiving information related to yaw rate, lateral acceleration, longitudinal acceleration of the vehicle, or other characteristics of vehicle operation for any reason, such as, but not limited to, controlling the brake system 100 during vehicle braking, stability operation, or other modes of operation. Additionally, the ECUs 210A, 210B may be connected to the instrument cluster for collecting and supplying information related to warning indicators such as an ABS warning light, a brake fluid level warning light, and a traction control/vehicle stability control indicator light. It is contemplated that at least one of the ECUs 210A and 210B may be, for example, integrated with the master cylinder 182 or the electric pump motor 202.

The first and second ECUs 210A and 210B may divide the control tasks for the brake system 100 in any desired manner, and may be readily configured by one of ordinary skill in the art for a particular use environment of a brake system, though it is contemplated that any control tasks performed by one or more ECUs 210 will be accomplished responsive to at least one brake pressure signal and/or a braking signal produced by the deceleration signal transmitter 184. For example, the first ECU 210A may be operative to control the electric motor 190 of the master cylinder 182. The second ECU 210B may be operative to control the electric pump motor 202, and potentially, as will now be discussed, at least one of the iso/dump control valve arrangements and at least one of the first and second traction control iso valve.

An iso/dump control valve arrangement is shown in FIG. 10 as being associated with each wheel brake 180 of the plurality of wheel brakes 180. Each iso/dump control valve arrangement includes an iso valve 212 and a dump valve 214, for providing desired fluid routing to an associated wheel brake 180. The reservoir 186 is hydraulically connected to the master cylinder 182 and to each of the iso/dump control valve arrangements, such as via the return line 216. The iso/dump control valve arrangements each include respective serially arranged iso and dump valves 212 and 214. The normally open iso valve 212 for each iso/dump control valve arrangement is located hydraulically between a respective wheel brake 180 and the master cylinder 182 and the normally closed dump valve 214 for each iso/dump control valve arrangement is located hydraulically between a respective wheel brake 180 and the reservoir 186, for the corresponding wheel brake 180.

The iso/dump control valve arrangements may selectively provide slip control to at least one wheel brake 180 powered by the master cylinder 182 and/or the secondary brake module previously mentioned. More broadly, the iso/dump control valve arrangement, and/or other valves of the brake system 178, any of which may be solenoid-operated and have any suitable configurations, can be used to help provide controlled braking operations, such as, but not limited to, ABS, traction control, vehicle stability control, dynamic rear proportioning, regenerative braking blending, and autonomous braking.

A first traction control iso valve 218 is hydraulically interposed between the master cylinder 182 and at least one iso/dump control valve arrangement via the first MC output 192. A second traction control iso valve 220 is hydraulically interposed between the master cylinder 182 and at least one iso/dump control valve arrangement via the second MC output 194. As shown in FIG. 10, it is contemplated that an iso/dump control valve arrangement may be associated with each wheel brake 180 of the first and second pairs of wheel brakes. The first traction control iso valve 218 is hydraulically interposed between the motor-driven master cylinder 182 and the iso/dump control valve arrangements of the first pair of wheel brakes 180. Similarly, the second traction control iso valve 220 is hydraulically interposed between the motor-driven master cylinder 182 and the iso/dump control valve arrangements of the second pair of wheel brakes 180.

As can be seen, each iso/dump control valve arrangement in the brake system 178 of FIG. 10 is in direct or indirect fluid communication with both a selected one of the first and second MC outputs 192 and 194 and a selected one of the first and second pump outputs 196 and 198 for selectively receiving pressurized fluid therefrom, such as during different braking modes or otherwise as desired. One of ordinary skill in the art will be readily able to configure a brake system 178 for any particular use application as desired.

A brake pressure signal is at least one input that an ECU 210 may consider and responsively control one or more other components of the brake system 178, to achieve desired braking results for a particular use environment. One potential source of the brake pressure signal is a brake pressure sensor. For example, and as shown in the Figures, the brake system 178 can include at least one, such as at least two, brake pressure sensors 222. As can be seen in FIG. 10, a first brake pressure sensor 222A may be interposed hydraulically between a selected iso/dump control valve arrangement and a corresponding rear brake of a chosen one of the first and second pairs of wheel brakes 180, and a second brake pressure sensor 222B may be interposed hydraulically between an other iso/dump control valve arrangement and a corresponding rear brake of an other one of the first and second pairs of wheel brakes 180. Either along with or instead of the first and second brake pressure sensors 222A, 222B, a third brake pressure sensor 222C may be interposed hydraulically between the first traction control iso valve 218 and the master cylinder 182, and/or a fourth brake pressure sensor 222D may be interposed hydraulically between the second traction control iso valve 220 and the master cylinder 182. One of ordinary skill in the art can readily provide a desired number/position/type of pressure sensors 138 for a particular brake system 100.

In the brake system 100 of FIG. 1, a single return line 216 places the reservoir 186 and each pump piston 200 in hydraulic connection. The brake system 178 also includes a pump inlet attenuator 224 interposed hydraulically between the reservoir 186 and the pump pistons 200 for “smoothing” fluid flow therebetween. The pump inlet attenuator 224 is in direct fluid connection with the reservoir 186 via the single return line 216 and regulates pressure in the single return line 216 to reduce pressure fluctuations at an inlet side of each pump piston 200 via solely mechanical pressure attenuation. At least a portion of the pump inlet attenuator 224 may be in fluid communication with an ambient space outside the brake system 178 as desired. The pump inlet attenuator 224 may be a single pump inlet attenuator 224 as shown and discussed herein, or it is contemplated that multiple pump inlet attenuators (not shown) may be provided for certain use environments of the brake system 178.

Known brake systems require the column of fluid in the return line 216 to accelerate and decelerate due to the flow ripple generated at the inlets of the pump pistons 202. This causes undesirable pressure ripple and decreased pump volumetric efficiency. Conversely, presence of the pump inlet attenuator 224 facilitates improved pump build rate performance with a smaller-diameter and/or longer return line 216. The pump inlet attenuator 224 (A.K.A., “pump inlet damper”) can be packaged inline in the return line 216 (e.g., in a reservoir hose adapter of the brake system 178) or “piggybacked” in a housing body structure of another component (e.g., a secondary brake module). Since the pump pistons 200 of the brake system 178 pull relatively low-pressure fluid from the return line 216 (within which the pump inlet attenuator 224 is inline), the pump inlet attenuator 224 does not need to be able to withstand the relatively high pressures developed in conduits sourced from the master cylinder 182. Thus, the pump inlet attenuator 224 can service both/all of the pump pistons 200 concurrently, but still with relatively inexpensive (e.g., molded plastic) components since the pump inlet attenuator 224 is operating in a low-pressure environment, as shown.

Conversely, and as previously mentioned, the accumulator assembly 100 shown in FIGS. 1-9 can be used in at least a medium-pressure environment. To that end, a first accumulator assembly 100A is interposed hydraulically between the first MC output 192 and at least one wheel brake 180 of the first pair of wheel brakes 180. A second accumulator assembly 100B is interposed hydraulically between the second MC output 194 and at least one wheel brake 180 of the second pair of wheel brakes 180. For example, and as shown in FIG. 10, the first and second accumulator assemblies 100A and 100B each are configured to provide pressurized hydraulic fluid to a corresponding front wheel brake 180 more quickly than either the motor-driven master cylinder 182 or the secondary brake module would be able to get pressurized hydraulic fluid to the corresponding front wheel brake(s) 180, given the brake system 178 configuration. This may be helpful, for example, during a “spike apply” situation or other quick-response command by a user (e.g., “slamming on” the brakes when a fast stop of a vehicle is desired), particularly when there is a running clearance between a brake pad and rotor that is desired to be taken up quickly.

The first and second accumulator assemblies 100A and 100B also may each facilitate a non-powered evac/fill phase of lifetime operation of the brake system, as previously mentioned, which could be helpful in efficient and expedient assembly/manufacture of a vehicle. It is also contemplated that the first and second accumulator assemblies 100A and 100B may facilitate recharging of the medium pressure accumulators 102 without the application of pressure to the corresponding wheel brake(s), but merely the use of “passthrough” fluid directly from one or more sources of pressurized hydraulic fluid (e.g., the motor-driven master cylinder 182 and/or the secondary brake module). Moreover, the MPA one-way valve 106 design provides a simpler (and thus potentially less expensive) valve package than in prior art versions which need to allow two-way fluid travel to and from an accumulator.

With reference again to FIG. 10, the reservoir 186 and motor-driven master cylinder 182 may be co-located in a first housing (indicated schematically by dashed line “1” in those Figures), and the secondary brake module may be located in a second housing (indicated schematically by dashed line “2” in those Figures), spaced apart from the first housing. Optionally, and also as shown in FIG. 10, the iso/dump control valve arrangements, the first and second accumulator assemblies 100A and 100B, and/or the first and second traction control iso valves 218 and 220 may also be located in the second housing.

The first and second housings (and included/co-located components) of any brake systems 178 may be provided and configured for a particular use application by one of ordinary skill in the art based upon factors including, but not limited to, achieving desired outcomes in at least one of design, manufacturing, service, spatial utilization in the vehicle, cost, size, regulatory compliance, or the like.

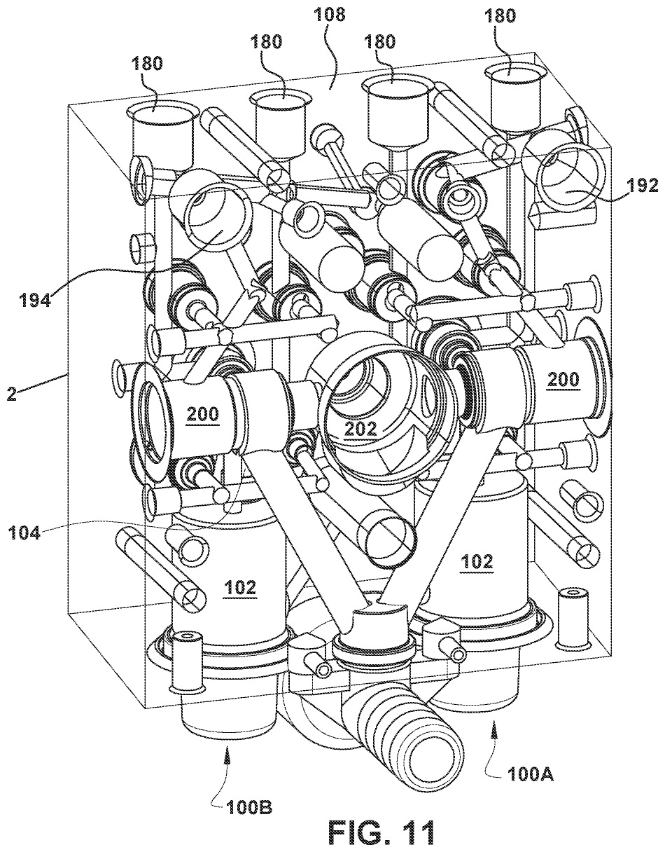

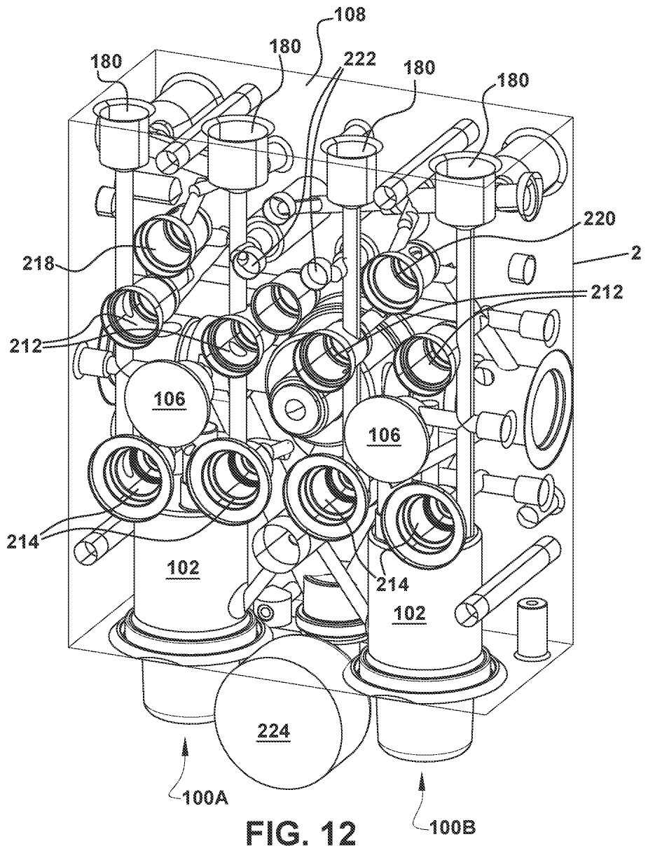

FIGS. 11-12 schematically depict an example arrangement, from opposite front/rear sides, of a second housing of a brake system 178 according to the previous description. In FIGS. 11-12, the block housing 108 is shown as a rectangular prism (labeled as “2” to correspond with the FIG. 10 labeling), with bores or cavities machined or otherwise produced therein for, or connecting fluidly to, the components as labeled. As can be seen in FIGS. 11-12, for example, the block housing 108 is similar to known block housings for other brake systems having low pressure accumulators and associated supply valves, but with the medium pressure accumulators 102 and MP one-way valves 106 of the accumulator assembly 100 in place of those components, respectively. This may assist with ease of design, manufacturing, sourcing, assembly, or otherwise be helpful in transitioning between use of the known block housings (for the prior art brake systems) and the block housing 108 associated with the present brake system 178. One of ordinary skill in the art can readily provide a block housing 108 configured to fit in a desired package configuration for a particular use environment.

It is contemplated that various other components, such as electric service and/or parking brake motors, could be provided by one of ordinary skill in the art to achieve desired configurations for particular use environments, in the brake system 178 described herein. For example, while a number of filters and pressure or other sensors are shown in the Figures, specific description thereof has been omitted herefrom for brevity, as one of ordinary skill in the art will readily understand how to provide a desired number, placement, and/or operation of filters, sensors, and any other components as desired for a particular use environment of the present invention.

It is contemplated that, while the various components are shown schematically in certain arrangements in the Figures, the components might not reach the precise relative configurations shown, depending on operating conditions in a particular use environment. For example, a poppet might not shuttle to entirely occlude an associated valve seat. However, one of ordinary skill in the art will understand which potential other positions may substantially produce a desired outcome, for a particular use environment. Various orifice sizes, fluid paths, hydraulic passageways, and other components of the accumulator assembly 100 can be configured by one of ordinary skill in the art to achieve desired operational characteristics of the accumulator assembly 100 in a particular use environment.

As used herein, the singular forms “a”, “an”, and “the” can include the plural forms as well, unless the context clearly indicates otherwise. It will be further understood that the terms “comprises” and/or “comprising”, as used herein, can specify the presence of stated features, steps, operations, elements, and/or components, but do not preclude the presence or addition of one or more other features, steps, operations, elements, components, and/or groups thereof.

As used herein, the term “and/or” can include any and all combinations of one or more of the associated listed items.

It will be understood that when an element is referred to as being “on”, “attached” to, “connected” to, “coupled” with, “contacting”, “adjacent”, etc., another element, it can be directly on, attached to, connected to, coupled with, contacting, or adjacent the other element, or intervening elements may also be present. In contrast, when an element is referred to as being, for example, “directly on”, “directly attached” to, “directly connected” to, “directly coupled” with, “directly contacting”, or “directly adjacent” another element, there are no intervening elements present. It will also be appreciated by those of ordinary skill in the art that references to a structure or feature that is disposed “directly adjacent” another feature may have portions that overlap or underlie the adjacent feature, whereas a structure or feature that is disposed “adjacent” another feature might not have portions that overlap or underlie the adjacent feature.

Spatially relative terms, such as “under”, “below”, “lower”, “over”, “upper”, “proximal”, “distal”, and the like, may be used herein for ease of description to describe one element or feature's relationship to another element(s) or feature(s) as illustrated in the figures. It will be understood that the spatially relative terms can encompass different orientations of a device in use or operation, in addition to the orientation depicted in the figures. For example, if a device in the figures is inverted, elements described as “under” or “beneath” other elements or features would then be oriented “over” the other elements or features.

As used herein, the phrase “at least one of X and Y” can be interpreted to include X, Y, or a combination of X and Y. For example, if an element is described as having at least one of X and Y, the element may, at a particular time, include X, Y, or a combination of X and Y, the selection of which could vary from time to time. In contrast, the phrase “at least one of X” can be interpreted to include one or more Xs.

It will be understood that, although the terms “first”, “second”, etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims or figures unless specifically indicated otherwise.

While aspects of this disclosure have been particularly shown and described with reference to the example aspects above, it will be understood by those of ordinary skill in the art that various additional aspects may be contemplated. For example, the specific methods described above for using the apparatus are merely illustrative; one of ordinary skill in the art could readily determine any number of tools, sequences of steps, or other means/options for placing the above-described apparatus, or components thereof, into positions substantively similar to those shown and described herein. In an effort to maintain clarity in the Figures, certain ones of duplicative components shown have not been specifically numbered, but one of ordinary skill in the art will realize, based upon the components that were numbered, the element numbers which should be associated with the unnumbered components; no differentiation between similar components is intended or implied solely by the presence or absence of an element number in the Figures. Any of the described structures and components could be integrally formed as a single unitary or monolithic piece or made up of separate sub-components, with either of these formations involving any suitable stock or bespoke components and/or any suitable material or combinations of materials. Any of the described structures and components could be disposable or reusable as desired for a particular use environment. Any component could be provided with a user-perceptible marking to indicate a material, configuration, at least one dimension, or the like pertaining to that component, the user-perceptible marking potentially aiding a user in selecting one component from an array of similar components for a particular use environment. A “predetermined” status may be determined at any time before the structures being manipulated actually reach that status, the “predetermination” being made as late as immediately before the structure achieves the predetermined status. The term “substantially” is used herein to indicate a quality that is largely, but not necessarily wholly, that which is specified—a “substantial” quality admits of the potential for some relatively minor inclusion of a non-quality item. Though certain components described herein are shown as having specific geometric shapes, all structures of this disclosure may have any suitable shapes, sizes, configurations, relative relationships, cross-sectional areas, or any other physical characteristics as desirable for a particular application. Any structures or features described with reference to one aspect or configuration could be provided, singly or in combination with other structures or features, to any other aspect or configuration, as it would be impractical to describe each of the aspects and configurations discussed herein as having all of the options discussed with respect to all of the other aspects and configurations. A device or method incorporating any of these features should be understood to fall under the scope of this disclosure as determined based upon the claims below and any equivalents thereof.

Other aspects, objects, and advantages can be obtained from a study of the drawings, the disclosure, and the appended claims.

1. An accumulator assembly, comprising:
a medium pressure accumulator, including an MPA cavity including at least one brake-side passage adjacent a first end thereof and including at least one pump-side passage adjacent the first end thereof,
an MPA piston for reciprocal longitudinal motion within the MPA cavity responsive to a predetermined amount of hydraulic fluid flow through at least one of the pump-side passage and the brake-side passage, and
an MPA biasing spring for urging the MPA piston toward the first end of the MPA cavity;
a nonpowered MPA fill valve interposed fluidically between the pump-side passage of the MPA cavity and a source of pressurized hydraulic fluid, the MPA fill valve including
an MPA fill valve cavity placing the pump-side passage of the MPA cavity and the source of pressurized hydraulic fluid in selective fluid communication via an MPA fill valve fluid path,
an MPA fill valve seat located along the MPA fill valve fluid path and at least partially defined by an interior wall of the MPA fill valve cavity,
an MPA fill valve poppet configured for reciprocal motion between a poppet rest position and a poppet closed position wherein an MPA fill valve poppet shoulder contacts the MPA fill valve seat to occlude fluid flow therepast along the MPA fill valve fluid path, and,
an MPA fill valve biasing spring urging the MPA fill valve poppet toward the poppet closed position, the MPA fill valve poppet selectively reciprocating responsive to at least one of biasing force from the MPA valve biasing spring and a fluid pressure differential between the source of pressurized hydraulic fluid and the MPA cavity; and
a powered MPA one-way valve interposed fluidically between the brake-side passage of the MPA cavity and the at least one corresponding wheel brake, the MPA one-way valve including
an MPA one-way valve cavity placing the brake-side passage of the MPA cavity and the at least one corresponding wheel brake in selective fluid communication via an MPA one-way valve fluid path,
an MPA one-way valve seat located along the MPA one-way valve fluid path and defined by an interior wall of the MPA one-way valve cavity,
an MPA one-way valve poppet configured for reciprocal motion between a poppet open position and a poppet closed position wherein an MPA one-way valve poppet shoulder selectively contacts the MPA one-way valve seat to occlude fluid flow therepast along the MPA one-way valve fluid path, reciprocal motion of the MPA one-way valve poppet occurring at least partially responsive to a predetermined amount of fluid pressure differential between the MPA cavity and the at least one corresponding wheel brake.

2. The accumulator assembly of claim 1, wherein the source of pressurized hydraulic fluid is at least one of a pump piston of a secondary brake module and a master cylinder.

3. The accumulator assembly of claim 1, wherein the MPA fill valve cavity includes an annular groove adjacent the pump-side passage of the MPA cavity, the annular groove being configured to retain a directional MPA lip seal therein, the MPA lip seal selectively permitting hydraulic fluid flow therepast toward the MPA cavity along the MPA fill valve fluid path.

4. The accumulator assembly of claim 3, wherein the MPA lip seal selectively permits airflow therepast toward the source of pressurized fluid along the MPA fill valve fluid path to provide an MPA bleed port function during a non-powered evac/fill phase of lifetime operation of the accumulator assembly.

5. The accumulator assembly of claim 4, wherein the MPA fill valve poppet includes an MPA bypass shoulder spaced apart from the MPA poppet shoulder, the MPA bypass shoulder selectively contacting an inner surface of the MPA lip seal to occlude airflow therepast toward the source of pressurized fluid along the MPA fill valve fluid path.

6. The accumulator assembly of claim 5, wherein the MPA fill valve poppet protrudes through the pump-side passage and is maintained at least partially within the MPA cavity with the MPA bypass shoulder in occluding contact with the inner surface of the MPA lip seal responsive to the MPA cavity containing a predetermined fill amount of hydraulic fluid.

7. The accumulator assembly of claim 6, wherein at least a first length of the MPA fill valve poppet is located within the MPA cavity when the MPA cavity includes the predetermined fill amount of hydraulic fluid and the at least one corresponding wheel brake is applied, the MPA fill valve poppet selectively reciprocates within the MPA fill valve cavity responsive to at least one of biasing force from the MPA valve biasing spring 142 and a fluid pressure differential between the source of pressurized hydraulic fluid and the MPA cavity, and a second length of the MPA fill valve poppet, smaller than the first length of the MPA fill valve poppet, is located within the MPA cavity at least when the MPA cavity includes the predetermined fill amount of hydraulic fluid.

8. The accumulator assembly of claim 1, wherein the MPA one-way valve includes an armature for selective longitudinally reciprocating motion with respect to the MPA one-way valve cavity between first and second armature positions, wherein the MPA one-way valve poppet is held into engagement with the MPA one-way valve seat, in the poppet closed position, responsive to the armature being in the first armature position, and wherein the MPA one-way valve poppet is permitted to selectively reciprocate between the poppet closed position and the poppet open position responsive to the armature being in the second armature position.

9. The accumulator assembly of claim 8, including a core for selectively magnetically attracting the armature, the core being located longitudinally directly adjacent a core-activated surface of the armature, the armature being longitudinally interposed between the core and the MPA one-way valve poppet, the core being selectively energized to magnetically drive the armature between the first and second armature positions.

10. The accumulator assembly of claim 8, including a poppet spring biasing the MPA one-way valve poppet toward the poppet closed position and sealing engagement with the MPA one-way valve seat when the armature is in the second armature position.

11. The accumulator assembly of claim 9, wherein a core sleeve is received at least partially in a housing also at least partially defining the MPA cavity, the core sleeve being configured to maintain the core in spaced relationship with the armature, the armature being at least partially enclosed within the core sleeve and guided thereby for selective longitudinal reciprocating motion with respect to the core responsive to energization of the core.

12. The accumulator assembly of claim 9, including a core spring biasing the armature toward the MPA one-way valve poppet.

13. The accumulator assembly of claim 11, wherein the core sleeve completely encloses the MPA one-way valve poppet, with a reduced-diameter sleeve shoulder, located on an opposite end of the MPA one-way valve poppet from the core, at least partially defining the MPA one-way valve seat by comprising at least a portion of an interior wall of the MPA one-way valve cavity.

14. The accumulator assembly of claim 1, wherein reciprocal motion of the MPA one-way valve poppet occurs at least partially responsive to a fluid pressure in the MPA cavity being greater than a predetermined wheel-side fluid pressure.

15. A brake system for actuating a plurality of wheel brakes comprising first and second pairs of wheel brakes, the system comprising:
a reservoir;
a motor-driven master cylinder operable during a normal non-failure braking mode by actuation of an electric motor of the master cylinder to generate brake actuating pressure at first and second MC outputs for hydraulically actuating the first and second pairs of wheel brakes, respectively;
a secondary brake module configured for selectively providing pressurized hydraulic fluid at first and second pump outputs for actuating the first and second pairs of wheel brakes in at least one of a normal non-failure braking mode and a backup braking mode, the secondary brake module including an electric pump motor configured to selectively pressurize the hydraulic fluid by transmitting rotary motion to at least two pump pistons, each pump piston providing pressurized hydraulic fluid to a corresponding one of the first and second pump outputs, each of the first and second pump outputs providing fluid to a corresponding one of the first and second pairs of wheel brakes;
first and second accumulator assemblies, with each accumulator assembly being interposed hydraulically between a corresponding first or second MC output and at least one wheel brake of a corresponding first or second pair of wheel, each of the first and second accumulator assemblies including a medium pressure accumulator, a nonpowered MPA fill valve interposed fluidically between a pump-side passage of the medium pressure accumulator and a source of pressurized hydraulic fluid, and a powered MPA one-way valve interposed fluidically between a brake-side passage of the medium pressure accumulator and the at least one corresponding wheel brake; and
an electronic control unit for controlling at least one of the secondary brake module and the master cylinder responsive to at least one braking signal;
wherein the first and second accumulator assemblies each facilitate a non-powered evac/fill phase of lifetime operation of the brake system.

16. The brake system of claim 15, including a pump inlet attenuator interposed hydraulically between the reservoir and the pump pistons and in direct fluid connection with the reservoir via a single return line.

17. The brake system of claim 15, including an iso/dump control valve arrangement associated with each wheel brake of the plurality of wheel brakes, each iso/dump control valve arrangement being controlled by the electronic control unit, and a chosen one of the first and second accumulator assemblies being interposed hydraulically between a corresponding one of the first and second MC outputs and at least one associated iso/dump control valve arrangement.

18. The brake system of claim 17, wherein reciprocal motion of the MPA fill valve poppet at least partially occurring responsive to at least one of an application status of at least one associated wheel brake, relative pressures within the MPA cavity and at least one other component of the accumulator assembly, and the operation of at least associated one iso valve of an iso/valve control valve arrangement.

19. The brake system of claim 15, including a first traction control iso valve hydraulically interposed between the motor-driven master cylinder and the first accumulator assembly via the first MC outlet; and
a second traction control iso valve hydraulically interposed between the motor-driven master cylinder and the second accumulator assembly via the second MC outlet.

20. The brake system of claim 15, wherein a first brake pressure sensor is interposed hydraulically between a selected iso/dump control valve arrangement and a corresponding rear brake of a chosen one of the first and second pairs of wheel brakes, and a second brake pressure sensor is interposed hydraulically between an other iso/dump control valve arrangement and a corresponding rear brake of an other one of the first and second pairs of wheel brakes.
